(19) United States
(12) Patent Application Publication
(10) Pub. No.: US 2007/0163316 A1
(43) Pub. Date: Jul. 19, 2007

(54) High organic matter products and related systems for restoring organic matter and nutrients in soil

(75) Inventors: Alvin W. Fedkenheuer, Calgary (CA); Christianne Carin, Priddis (CA); Alexander Starosud, Calgary (CA)

Correspondence Address: BUCHANAN, INGERSOLL & ROONEY PC, POST OFFICE BOX 1404, ALEXANDRIA, VA, 22313-1404, US

(73) Assignee: EarthRenew Organics Ltd., Calgary (CA)

(21) Appl. No.: 11/335,854

(22) Filed: Jan. 18, 2006

(51) Int. Cl. C05D 9/02; A01N 59/04

(52) U.S. Cl. 71/11; 504/101

(57) ABSTRACT

This invention relates to high organic matter plant food products for agronomic uses. Also disclosed are combination products comprising the high organic matter plant food products, articles made from and incorporating same and methods of using same in agricultural operations for restoration and/or maintenance of organic matter values and/or nutrient values in soils, particularly certified organic farm soils.

### FIELD OF THE INVENTION

This invention relates to high organic matter plant food products for agronomic uses. Also disclosed are combination products comprising the high organic matter plant food products, articles made from and incorporating same and methods of using same in agricultural operations for restoration and/or maintenance of organic matter values and nutrient values in soils, particularly certified organic farm soils.

### BACKGROUND OF THE INVENTION

There is an increasingly serious problem in almost all aspects of agriculture of depletion of organic matter in the soils. This problem exists throughout the agricultural spectrum of operations from produce farms, silage and cattle feed farms, turf farms, golf courses, commercial landscape and residential lawns to many other agricultural operations. The problem is becoming most acute in operations where a green crop is grown, cut and taken away from the growing site. And the problem is exacerbated by conventional chemical fertilizer application, which merely accelerates or enhances the growth of the green crop which is taken away, thus depleting the organic matter in the soil even more rapidly. Chemical fertilizers do not usually contribute to restoring or maintaining organic matter content in the soil. The problem is not quite as acute in some crop operations, like grain production, where straw or stalks are returned to the soil after harvest, but those soils are nevertheless being depleted of organic matter as well.

Soils that are depleted of organic matter or have lower than needed organic matter content have reduced nutrient holding capacity (cation exchange capacity). Such soils are not capable of adequately retaining nutrients, including those from conventional N—P—K chemical fertilizers, in the plant root zone in plant available form for plant uptake. Consequently, the nutrients from chemical fertilizer values leach out of the soils from rain or over watering and contaminate surface and ground water. The contamination problem is compounded by the fact that, when the chemical fertilizer leaches out and is not effective in greening or growing the crop, the operator frequently applies yet more chemicals that leach out. Without proper maintenance of organic matter content in the soil, the result is an endless and shortening cycle resulting in more intense surface and groundwater contamination.

The federal, state and provincial Environmental Protection Agencies, as well as local county and city government agencies, are bringing increased attention to this contamination problem caused by chemical fertilizers leaching out of soils. Proposed regulations restricting or limiting chemical fertilizer usage in many applications, such as golf courses, are under consideration or already in effect at various levels of government.

The agricultural industries do not have solutions to the depleting organic matter problem that are feasible or economically viable. Current practices for organic matter maintenance and restoration include green manure crops, peat, compost, raw or decomposed animal manures and similar methods. Green manure is somewhat effective in organic matter maintenance but requires removing the land from normal production for one or more regular growing cycles while a green manure crop, such as sudan grass, is grown then plowed under. This practice reduces the economic viability of many operations, and is not practical in many operations, such as golf courses, orchards and vineyards. Peat is difficult to apply on a large scale and is expensive on an organic matter basis due to the high water content. Compost materials are not very effective and have components such as weed seed and other contaminants that cause problems in the agricultural operation. Compost is also difficult to apply and has its own set of environmental problems including dust and particulates, greenhouse gas emissions and surface and ground water contamination, particularly at the composting site. Raw and decomposed or composted manures have similar problems as other compost and are restricted in application to human food crops due to pathogen contamination.

Therefore, it is apparent there is a need for an effective and economically viable solution to the problems of organic matter depletion in soils. The products and methods of this invention provide solutions to these problems.

Another aspect of soil maintenance is the need for nutrient (and organic matter) replacement and maintenance in certified organic food production and the necessity of using inputs that are qualified as organic for certified organic crop production. Some manure, compost and similar materials qualify as organic inputs, but are replete with the drawbacks mentioned above and other problems. Technology developed to date for producing certified organic fertilizer products has not been satisfactory due to one or more problems in product quality, environmental acceptability or economic feasibility of providing a reasonably priced commercial product. Examples of the prior art and publications that have addressed the production of organic fertilizer products are U.S. Pat. No. 5,354,349 to Inoue; U.S. Pat. No. 6,461,399 to Connell; U.S. Pat. No. 6,517,600 and U.S. Pat. No. 6,645,267 to Dinel; U.S. Patent Applications 2003/0038078 by Stamper et al., 2003/0089151 and 2003/0136165 by Logan et al., and 2003/0111410 by Branson, the disclosures of which are incorporated herein by reference in their entirety.

There is a substantial unmet need for environmentally acceptable and economically feasible technologies for cost-effective products and systems for providing organic matter restoration and maintenance of soils, and systems for providing restoration and maintenance of not only organic matter but plant available nutrients in certified organic farm soils. The present invention is directed to products, methods, and systems for meeting some or all of these needs.

### SUMMARY OF THE INVENTION

The present invention provides economical and simplified products, methods and systems for increasing organic matter of soils with organic plant food products that are high in organic matter and low in moisture content. The present invention further provides economical and simplified products, methods, and systems for providing organic plant food products for certified organic farming that restore and/or maintain both organic matter content and plant available nutrient content of soils.

In another aspect, this invention includes methods for producing organic plant food products high in organic matter and low in water content comprising drying an organic feedstock and preferably thermally converting components therein to provide self-binding properties in the organic plant food products.

In another aspect, this invention provides novel organic plant food products and materials of this invention are formed from organic feedstock and are characterized by high organic matter content of greater than about 60% by weight and low moisture content of less than about 20% by weight. Preferably the organic matter content is greater than about 70%, or about 80% or about 90% by weight and the moisture content is less than about 15% or about 10% or about 8% by weight. The novel organic plant food products and materials of this invention are also characterized by a high weigh ratio of organic matter to moisture of at least about 1.5:1, preferably at least about 3:1 and more preferably at least about 4:1 or about 5:1 or about 8:1 or about 9:1 or higher.

In another aspect, this invention provides an organic plant food product having an organic matter to water weight ratio of at least about 1.5:1, preferably at least about 2:1 and most preferably greater than 9:1.

In another aspect, this invention provides novel organic plant food products and materials of this invention comprising high organic matter formed from undigested organic feedstock, which means organic feedstock that substantially fresh, such as fresh organic waste, and has not undergone significant digestion, composting or decomposition. These preferred novel organic plant food products and materials of this invention are also characterized by high organic matter content of greater than about 60% by weight and low moisture content of less than about 20% by weight and preferably the organic matter content is greater than about 70%, or about 80% or about 90% by weight and the moisture content is less than about 15% or about 10% or about 8% by weight. These novel organic plant food products and materials of this invention are also characterized by a high weigh ratio of organic matter to moisture of at least about 1.5:1, preferably at least about 3:1 and more preferably at least about 4:1 or about 5:1 or about 8:1 or about 9:1 or higher.

In another aspect, this invention provides a high organic matter, low moisture organic plant food product in combination or mixture with one or more conventional chemical fertilizers.

In another aspect, this invention provides a high organic matter, low moisture organic plant food product in combination with one or more biopesticides.

In another aspect, this invention provides a high organic matter, low moisture organic plant food product in combination with one or more conventional pesticides.

In another aspect, this invention provides organic plant food products and materials of this invention provide novel shaped products and articles due to the self-binding properties of the organic plant food products and materials of this invention. The self-binding properties of the products and materials enable the formation of the materials and products into shapes and articles without the necessity of the addition of polymeric or other binder materials. Although optional and conventional binders can be added to the organic plant food products and materials of this invention when shaped into articles in order to provide particular strength properties desired in the final article, a preferred embodiment of this aspect of this invention is to form such articles utilizing the self-binding properties of the organic plant food products and materials of this invention.

In another aspect, this invention provides methods of producing crops using the organic plant food products or materials of this invention by the steps of applying the organic plant food products or materials of this invention to the soil, planting the crop in that soil and harvesting the crop, or applying the organic plant food products or materials of this invention to the soil where a crop is growing and harvesting the crop.

In another aspect, this invention provides methods of producing meat or dairy products using the organic plant food products or materials of this invention by the steps of applying the organic plant food products or materials of this invention to the soil, planting the crop in that soil and harvesting the crop, or applying the organic plant food products or materials of this invention to the soil where a crop is growing harvesting the crop, feeding the harvested crop to cattle and producing meat products or dairy products from those cattle.

The above aspects and other aspects will be apparent to one skilled in the art from the disclosure herein.

### DESCRIPTION OF THE INVENTION

This invention provides economical, efficient and simplified solutions to problems of less than desired levels of crop production caused by depletion of organic matter and nutrients in soils and the increasingly severe problem of environmental pollution caused by depletion of organic matter in soils and application of chemical fertilizers.

The present inventions provide new technology in the form of organic plant food products, including processes and systems for use thereof, that have high organic matter and low moisture. These organic plant food products can be produced in any solid form desired, such as powder, flakes, granules, pellets, prills, blocks, molded and shaped articles and other forms, as well as in slurry form. A full description of the apparatus, methods and systems for novel and economic production of these organic plant food products is contained in copending and commonly assigned U.S. patent applications Ser. Nos. 11/184,738 and 11/184,739 filed Jul. 18, 2005, the disclosures of which are incorporated herein by reference in their entirety. The present inventions are directed to the organic plant food products and their uses in various methods and combinations with other materials, while the methods, apparatus and systems enabling the manufacture and production of the organic plant food products are disclosed in said copending applications incorporated herein.

The term “organic feedstock” is used herein to mean and include organic waste and other materials which comprises organic matter, but can optionally include inorganic matter in mixture therewith. The organic feedstock will usually be waste organic material due to economic reasons, but can be virgin organic materials as well. Included in the organic waste matter category are: manure feedstock, woody or cellulosic and chemical waste products from agricultural operations, such as bagasse, rice hulls, straw, alfalfa, orchard and vineyard prunings, citrus pulp, corn cobs, beet pulp, hatchery waste, yard wastes, landscaping wastes, mushroom growing wastes, etc., from forestry and lumber operations, such as scrap wood, sawdust, bark, limbs, etc., from pulp and paper operations, including Kraft mill black liquor from sulfate pulping, from de-inking mill operations, from nursery operations, such as dead or diseased plants; food processing wastes from processed or pre-processed food product manufacturing, such as such as frozen foods, pre-prepared, ready-to-eat salad mixes, heat-and-serve meals, canned foods, and food services businesses, such as restaurants, institutional meal providers, airline meal providers, etc.; residual meat, bones, offal, skin, poultry waste, feathers, feather meal, hair, hair meal, seafood meal, blood, blood meal, bone meal etc. from slaughter house and meat and fish packing operations; livestock, poultry and pet carcasses from farms, feedlots, slaughter houses, and veterinarian clinics, including cattle, sheep, goats, hogs, horses, chickens, geese, ducks, and virtually any other animal from any source of carcasses, body parts, organs or tissues that must be disposed of; body parts, organs and tissues from medical facilities; fermentation and distillation operation wastes, such as soy sauce waste, wine and sake lees, tofu refuse, grape skins and seeds, mash and sour mash residue, cheese making operations, recycle waste operations, such as paper, cardboard, etc. and other servicing, processing and manufacturing operations that involve organic materials. Typically, the waste material will have a high water content, as discussed below. The term “manure feedstock” is used herein to mean and include waste matter excreted from animals as feces and/or urine, such as but not limited to human (municipal sewage, raw or sludge), cattle (beef, dairy, buffalo, veal, etc.), horses, sheep, swine, poultry (chicken, turkey, ostrich, pigeon, etc.), goat, mink, veterinarian, stockyard, stable, race track, rodeo grounds, fairgrounds, feedlot, sale barn, zoo, aquatic (fish, shrimp, etc.), elk (and other game), llama, alpaca, as well as other operations and sources of sewage or manure, and any mixtures thereof. Manure feedstock as used herein includes such matter along with other materials normally present in agricultural operations where such matter is produced, such as straw, bedding (which is typically shredded paper, wood chips, etc.), hair, feathers, insects, rodents, etc., whether the ratio of such matter to such other materials ranges from very low to very high. Manure feedstock as used herein includes such matter in its raw form, any prepared form and mixtures thereof with other materials such as other bio matter (yard waste, green waste, etc.), additives, process aids, bone meal, fish meal and the like, including where the matter is fresh, fully bioconverted by composting, digestion, etc., or is at any stage in between, because even composted organic material still contains organic matter useful in this invention. It will be recognized that, when other components, such as bone meal, etc., are added to, mixed with or included in the manure feedstock for processing according to this invention, such additional components will also benefit from the thermal destruction or conversion of the undesirable components listed above, such as prions, etc., just as the manure feedstock does. Thus, it may be desirable to mix contaminated materials, such as straw containing pesticides, bone meal containing prions, etc., with the manure to be processed, so that those contaminants can be converted or destroyed during the processing of the manure feedstock to produce the organic plant food products of this invention. The term “organic feedstock” is also used herein to include intermediate products and raw materials for further processing into other products which are not waste products. For example, the processes in said copending applications for making the products of the invention provide economical processes and systems for removal of water from various organic materials and process streams and/or provide heating to thermally convert or react the organic matter to a converted or reacted product (in batch or continuous operations), which forms the organic matter plant food of this invention. Other examples of the various sources of feedstock for producing the organic plant food products of this invention include drying and treating slaughterhouse waste, processing lumber and paper manufacturing wastes or intermediate streams to produce recyclable cellulose, paper or wood materials or products useful in manufacture of particle board, cardboard, etc., drying and processing potato peelings and other waste from potato processing facilities, removing water from and/or converting (cooking, pasteurizing, sterilizing, etc.) process streams in human food production facilities, such as production of oatmeal, corn flakes, corn syrup, corn meal, mashed potatoes, sugar, milk, cheese, snack foods and other food products such as pet food; and removing water from and/or converting or reacting process streams in drug, chemical and other manufacturing facilities to produce organic plant food products of this invention.

The self-binding properties of the organic plant food products of this invention are a preferred aspect of this invention. Conventional binders and additives can optionally be used to provide desired physical strength properties of the granules, pellets, prills, molded shapes, articles and other forms of the organic plant food products of this invention. However, it is preferred that the organic feedstock be processed to produce the organic plant food product of this invention so that it is self-binding, as described in the above referenced copending applications. While not understood and not being bound by any particular theory, it is believed that starch, protein, carbohydrate and sugar components present in organic feedstock are converted to glutenous-like materials that can act as binders and that oil and ligand-type components are polymerized to act as binders. Optimum conditions to achieve an optimum self-binding product can be determined for a particular organic feedstock following the disclosures therein. The solid shapes in which the organic plant food product, from granules to molded shapes can be achieved with added binders or without added binders.

As used herein the term “organic plant food product” is used to refer to and means a processed organic feedstock which is produced by reducing the moisture content of the organic feedstock from a higher level to a lower level according to this invention and the processes described in said copending applications and/or achieving the chemical alterations and conversions referred to herein and in said copending applications. The term “organic plant food material” is used to refer to and to mean an intermediate material that is suitable for further processing into a final organic plant food product suitable for consumer, commercial or industrial use. Typically the material from the dryer vessel and the drying step used in the apparatus and process for conversion of organic feedstock to the organic plant food materials and organic plant food products of this invention will be processed by milling to produce a powder or meal, followed by granulating, pelletizing or prilling of the powder or meal to produce the final organic plant food product suitable for dry application in a crop growing operation. The organic plant food material can also be milled or otherwise powdered and made into a slurry or other liquid or pumpable product that can be applied to the soil or in a crop growing operation in wet form, or pressure applied to hills or cliffs in remediation or seeding type applications, such as hydro-mulching, hydro-seeding and hydro-sprigging, or can be used to coat seeds for such uses or for seed drills or aerial planting. Similarly, the material the dryer vessel produces may optionally be processed to form a baled or packaged product similar to natural peat, but having much higher (by 20%, 30%, 40%, 50% or 60% or more) organic matter to moisture ratio than natural peat. In the case where the organic feedstock is partially or mostly bioconverted or digested, such as sewage sludge, the material produced by the dryer vessel can still be formed into a peat-like product which is useful as a soil builder product. Even though such product may not be as high in nutrient value as produced from undigested feedstock, it will have the high organic matter to moisture ratio according to this invention. The raw output from the dryer vessel, whether from fresh or bioconverted feedstock, can be the final organic plant food product which can be baled, packaged or shaped in a form desired and suitable for use in various agricultural and landscape operations. For example, it can be formed in long “snake” rolls, similar to the straw snake rolls, for use in erosion control at construction sites. Such rolls made from the materials of this invention will be just as effective at physical erosion control as straw rolls, but due to the higher nutrient and/or higher organic matter content compared to straw, such rolls will encourage and enable earlier and more vegetation growth due to the organic matter added to the soil by the organic plant food products of this invention at that site for vegetation erosion control after the rolls are disintegrated and no longer effective as a physical barrier. The organic plant food material from the dryer vessel can also be combined with binders, such as molten urea, to form a products for agricultural use. It is recognized that these materials or products can be blended with other materials or chemicals as disclosed elsewhere herein.

The novel organic plant food products and materials of this invention are characterized by high organic matter content of greater than about 60% by weight and low moisture content of less than about 20% by weight. Preferably the organic matter content is greater than about 70%, or about 80% or about 90% by weight and the moisture content is less than about 15% or about 10% or about 8% by weight. The novel organic plant food products and materials of this invention are also characterized by a high weigh ratio of organic matter to moisture of at least about 1.5:1, preferably at least about 3:1 and more preferably at least about 4:1 or about 5:1 or about 8:1 or about 9:1 or higher. The novel organic plant food products and materials of this invention preferably comprise organic matter formed from undigested organic feedstock, which means organic feedstock that substantially fresh, such as fresh organic waste, and has not undergone significant digestion, composting or decomposition. These preferred novel organic plant food products and materials of this invention are also characterized by high organic matter content of greater than about 60% by weight and low moisture content of less than about 20% by weight and preferably the organic matter content is greater than about 70%, or about 80% or about 90% by weight and the moisture content is less than about 15% or about 10% or about 8% by weight. These novel organic plant food products and materials of this invention are also characterized by a high weigh ratio of organic matter to moisture of at least about 1.5:1, preferably at least about 3:1 and more preferably at least about 4:1 or about 5:1 or about 8:1 or about 9:1 or higher. Either or both of the above novel organic plant food products and materials of this invention are preferably dried and converted organic feedstock, preferable undigested, sufficiently dried and treated at temperatures and for times such that the resulting product is sufficiently self-binding to for stable granules or other shapes suitable for commercial use. The temperatures and times for converting an organic feedstock to a self-binding product are disclosed into the above referenced copending applications.

The organic plant food products and materials of this invention provide novel products and articles due to the self-binding properties of the organic plant food products and materials of this invention. The self-binding properties of the products and materials enable the formation of the materials and products into shapes and articles without the necessity of the addition of polymeric or other binder materials. Although optional and conventional binders can be added to the organic plant food products and materials of this invention when shaped into articles in order to provide particular strength properties desired in the final article, a preferred embodiment of this aspect of this invention is to form such articles utilizing the self-binding properties of the organic plant food products and materials of this invention. Examples of the shapes and articles that can be made using the organic plant food products and materials of this invention are shown in U.S. Pat. No. 6,322,734 to Zanten et al., the disclosure of which is incorporated herein by reference, wherein rooting media or grow plugs are disclosed as made from a complex mixture of peat, soil or vermiculite with a polymeric binder. In the present invention, the organic plant food product and materials can be formed into such shapes without the need for a binder. Other shapes the self-binding organic plant food products and materials of this invention can be formed include pots, multi-compartment trays and strips, seed holding pellets and other conventional shapes used by the greenhouse and other horticulture industries. Advantages of the molded and shaped articles formed from the self-binding organic plant food products and materials of this invention include the lower cost of manufacture, since a binder is not needed, and the organic matter benefit to the soil in which the plugs, pots or other shapes are placed for the seeds or seedlings to grow with no undesired residue, like polymeric binder material, left in the soil. The methods of forming, molding or shaping the organic plant food products and materials of this invention into desired plugs, pots, etc. are the conventional methods of forming the material in a slurry, casting in open molds or molding under pressure to form the desired shape and drying the moisture content to the desired level to provide the desired strength of the article or shape. Such conventional methods are disclosed in the above Zanten et al. reference incorporated herein by reference and in references cited therein.

The organic plant food products of this invention are preferred for use in certified organic farming, because the products of this invention contain high organic matter and organic soil nutrients, especially nitrogen, and do not contain viable weed seeds or pathogens. However, the organic plant food products and materials of this invention are also advantageous to use in conventional and non-certified organic farming where, on an equivalent nitrogen basis, the organic plant food products and materials of this invention can provide a 10% increase in crop yield compared to chemical fertilizer, which is believed due to the organic matter content of these products more effectively holding the nitrogen in the soil for plant uptake and/or the organic nitrogen in these products performing more like a slow release nitrogen, providing increased effectiveness of the nitrogen nutrient values. The organic plant food products of this invention are also useful in combination with conventional chemical fertilizers. The power, granular, prill or other forms of the organic plant food products of this invention can be mixed or blended with chemical fertilizers, preferably those of similar physical properties, which provides the most stable mixture where the components do not settle or separate out during transport, storage or use. One advantage of such mixtures or combinations of the organic plant food products of this invention and conventional chemical fertilizers is that the high organic matter content of the organic plant food products of this invention enhance the ability of the soil to hold the chemical fertilizer from leaching out and make the chemical fertilizer more available or available longer for plant uptake. The organic plant food products of this invention can be used with chemical fertilizers in any blend or ratio and can be used in combination with more than one chemical fertilizer as determined to be desirable or useful for a particular soil condition or crop usage. The mixtures or blends of the organic plant food products of this invention with chemical fertilizer(s) can be in any weight ratio of less than about 1:10 to more than about 10:1, or in the range of about 1:5 to about 5:1, or any other ratio or any particular ratio one skilled in the art determines is appropriate or desirable following the disclosure herein depending on the soil, the crop, the nutrient balance desired and the organic matter balance desired.

The organic plant food products of this invention are preferred for use in certified organic farming, for the reasons noted above, which makes these products especially suited for use in conjunction with, in combination with or in mixture with other approved inputs for certified organic farming, such as biopesticides. In general, the biopesticides that are preferred for use with the organic plant food products of this invention are the powder or granular products that are normally applied to the soil for control of pest organisms in the soil or control of unwanted vegetation growth. For example, corn gluten in meal or granular form is applied to lawns for prevention of growth of dandelions, crabgrass, lambs quarter and foxtail, and is available as the “WOW” product line from Gardens Alive in Lawrenceburg, Ind. This product can be mixed or blended with organic plant food products of this invention in granular form and the mixture applied to the lawn by conventional broadcast or drop lawn spreader. Examples of other granular biopesticide products that can be blended or mixed with the organic plant food products of this invention include the “RootShield”, “RootMate” and “TurfShield” line of products from BioWorks, Inc. in Fairport, N.Y. and the “SoilGard” products from Certis USA in Columbia, Md. Other biopesticide products can be used in conjunction with the organic plant food products of this invention, such as the foliage spray products from AgraQuest Inc. in Davis, Calif. in the “Serenade” and “Rhapsody” product lines. Although these spray products would not be mixed with the organic plant food products of this invention, use at the same time can provide benefits of healthier plants growing with more organic matter in the soil being more resistant to pests after the biopesticide has brought the pest in question under control. A source of organic biopesticides is http://www.epa.gov/pesticides/biopesticides/ingredients/index.htm where the US EPA provides a regularly updated listing of biopesticides. Also, the organic plant food products of this invention can be in the form of a liquid slurry, in which case a liquid form biopesticide can be mixed or blended with the organic plant food products of this invention for use by application to the soil. Although the organic plant food products of this invention are usually preferred for use in certified organic farm operations, with or without a biopesticide, the organic plant food products of this invention are also useful in non-certified organic conventional farming, and in those applications can be used in combination with any compatible conventional chemical pesticide desired for a particular application. As noted above, the chemical pesticide can be selected for any particular pest problem, or a combination selected as needed, and can be mixed or combined with the organic plant food products of this invention in either granular or liquid slurry form for use by application to the soil. In both the organic and non-organic applications of the mixtures or blends of the amount of biopesticide or chemical pesticide used with the organic plant food products of this invention can be in any weight ratio of less than about 1:10 to more than about 10:1, or in the range of about 1:5 to about 5:1, or any other ratio or any particular ratio one skilled in the art determines is appropriate or desirable following the disclosure herein depending on the soil, the crop, the nutrient balance desired, the organic matter balance desired and the pest or pests to be treated.

This invention provides methods of producing crops using the organic plant food products or materials of this invention by the steps of applying the organic plant food products or materials of this invention to the soil, planting the crop in that soil and harvesting the crop, or applying the organic plant food products or materials of this invention to the soil where a crop is growing and harvesting the crop. The amount of the organic plant food products or materials of this invention to be applied to the soil will be that which one skilled in the art determines is appropriate or desirable following the disclosure herein depending on the soil, the crop, the nutrient balance desired and the organic matter balance desired in the particular soil. This invention further provides methods of producing meat or dairy products by the above method with the added steps of feeding the harvested crop to cattle and producing meat products or dairy products from those cattle.

As used herein the term “granule,” “granulating” and the like refer to any granular form of the organic plant food products or materials of this invention, including conventional granules, powder, dust, crumbs and the like, produced by conventional granulation processes and equipment, including crushing or crumbling previously formed pellets or prills. The term “pellets,” “pelletizing” and the like refer to any pellet form of the organic plant food products or materials of this invention, including cylindrical, bullet, spherical or other shape, typically made by conventional pelletizing processes and equipment, such as by extruding a slurry or paste and cutting, chopping, or breaking the extrudate to the desired size. The terms “prills,” “prilling” and the like refer to any prill form of the organic plant food products or materials of this invention made by conventional prilling processes and equipment, including spray tower processes, freeze drying processes, etc.

The solids output from the dryer vessel referred to in the above referenced copending applications is referred to herein as the organic plant food material of this invention, which solids are typically further processed by milling, granulating, pelletizing, prilling or other processing to produce the final organic plant food products of this invention in the form desired for final packaging or for bulk distribution. Such milling, granulating, pelletizing or prilling equipment and operations are those that are conventional and well-known.

The organic plant food products or materials of this invention are useful for and include blends with other materials, products or chemicals, as may be desired for particular end uses requiring particular properties or characteristics. Such other materials and additives can be added and blended at any appropriate point in the process described in the copending applications: blended with the manure feedstock, added to the dryer vessel, added in the process water at any point, added to the material exiting the dryer vessel, added as part of any milling, granulating or pelletizing processing or simply mixed with the final product or blended in before bagging or packaging or at the point of use. For example the organic plant food products or materials of this invention, while usually relatively odor free, can be blended with other materials that can either provide a pleasant odor or mask any unpleasant odor. Such materials can be synthetic (perfumes) or natural, with natural materials being preferred. Natural, organic materials can include sage, mint, fennel, garlic, rosemary, pine, citrus and similar materials that would not prevent qualifying as an organic input when desired. Other materials for blending can include iron, minerals, carbon, zeolite, vermiculite, perlite, chemical fertilizers (urea, ammonium nitrate, etc.), pesticides and other materials to adapt the organic plant food products or materials of this invention for specialized use. Although certified organic products are the most preferred products of this invention, the products of this invention can include any conventional NPK fertilizer blend or mixture in any conventional form, including extended release forms. For example, the organic plant food products or materials of this invention may include added herbicides (for typical “weed and feed” products) and other additives that may be organic based or chemical that may or may not qualify for certified organic status. It is well known in the art to make fertilizer products in desired granule or particle size having desired hardness and integrity in dry form, but readily dispensable when applied to an agricultural operation and treated with water by irrigation or rainfall. For example, see U.S. Pat. No. 4,997,469 to Moore and U.S. Pat. No. 5,676,729 to Elrod et al., the disclosures of which are incorporated by reference in their entirety.

As described in the copending applications, the exhaust gases from the gas turbine are contacted with the organic feedstock, where at least some of the NOₓ and SOₓ and COₓ gases are absorbed into or complexed with the organic feedstock as it is dried and/or converted to an organic plant food material, and preferably to a self-binding organic plant food material or product.

While we have illustrated and described various embodiments of this invention, these are by way of illustration only and various changes and modifications may be made within the contemplation of this invention and within the scope of the following claims.

We claim:

1. An organic plant food product or material formed from organic feedstock and characterized by high organic matter content of greater than about 60% by weight and moisture content of less than about 20% by weight.

2. An organic plant food product or material according to claim 1 comprising an organic matter content greater than about 70% by weight and a moisture content of less than about 15% by weight.

3. An organic plant food product or material according to claim 1 wherein the product or material comprises self-binding properties.

4. An organic plant food product or material according to claim 1 wherein the feedstock comprises undigested feedstock.

5. An organic plant food product or material formed from organic feedstock and having an organic matter to moisture weight ratio of at least about 1.5:1.

6. An organic plant food product or material according to claim 5 wherein the weight ratio is at least about 8:1.

7. A method for producing organic plant food products comprising high organic matter and low water content comprising drying an organic feedstock or an undigested feedstock.

8. A method according to claim 7 comprising thermally converting components therein to provide self-binding properties in the organic plant food products.

9. A combination product comprising a high organic matter, low moisture organic plant food product in combination or mixture with one or more conventional chemical fertilizers.

10. A combination product comprising a high organic matter, low moisture organic plant food product in combination with one or more biopesticides.

11. A combination product comprising a high organic matter, low moisture organic plant food product in combination with one or more conventional pesticides.

12. An article or shape formed from products or materials comprising organic plant food.

13. An article or shape according to claim 12 wherein the organic plant food is self-binding and capable of forming the article or shape without added binders.

14. An article or shape according to claim 12 comprising a chemical fertilizer, a pesticide, a biopesticide, a zeolite or a vermiculite.

15. A method of producing a crop comprising applying an organic plant food having high organic matter and low moisture to the soil, planting the crop in the soil and harvesting the crop.

16. A method of producing a crop comprising applying an organic plant food having high organic matter and low moisture to soil containing a growing crop and harvesting the crop.

17. A method of producing a meat product or a dairy product comprising feeding the harvested crop of claim 15 or claim 16 to cattle and producing the meat or dairy product from those cattle.

18. A method of forming a combination product comprising mixing an organic plant food having high organic matter and low moisture with a chemical fertilizer, a pesticide, a biopesticide, a zeolite or a vermiculite.
